(19) United States
(12) Patent Application Publication
(10) Pub. No.: US 2015/0004590 A1
(43) Pub. Date: Jan. 1, 2015

(54) SYSTEM AND METHOD FOR SUPPORTING TRAINING OF AIRPORT FIREFIGHTERS AND OTHER PERSONNEL

(71) Applicant: Dallas/Ft.Worth International Airport Board, Dallas, TX (US)

(72) Inventors: Brian K. McKinney, Grand Prairie, TX (US); Michael W. Foster, Fort Worth, TX (US); Charles W. Knowles, JR., Saginaw, TX (US); Paul R. DeVaul, Keller, TX (US); David G. Henderson, Little Elm, TX (US); Matthew R. Bugbee, McKinney, TX (US); Zachary E. Brackin, The Colony, TX (US); Daniel A. Dura, Garland, TX (US); Christopher R. Barker, McKinney, TX (US)

(21) Appl. No.: 14/320,141

(22) Filed: Jun. 30, 2014

Related U.S. Application Data
(60) Provisional application No. 61/841,876, filed on Jul. 1, 2013.

(51) Int. Cl. G09B 5/02; A62C 99/00; G09B 9/00

(52) U.S. Cl. CPC G09B 5/02; G09B 9/00; A62C 99/0081
USPC 434/350; 434/362

(57) ABSTRACT

A method includes generating a graphical user interface for presentation on at least one display device. The graphical user interface includes one or more first screens that display different types of aircraft. The one or more first screens include first controls that allow a user to navigate around both an exterior of each aircraft and an interior of each aircraft within the one or more first screens. The graphical user interface also includes one or more second screens that display at least one airport. The one or more second screens include second controls that allow the user to navigate around each airport within the one or more second screens.

### CROSS-REFERENCE TO RELATED APPLICATION AND PRIORITY CLAIM

This application claims priority under 35 U.S.C. §119(e) to U.S. Provisional Patent Application No. 61/841,876 filed on Jul. 1, 2013, which is hereby incorporated by reference in its entirety.

### TECHNICAL FIELD

This disclosure relates generally to training systems. More specifically, this disclosure relates to a system and method for supporting training of airport firefighters and other personnel.

### BACKGROUND

Aircraft rescue and firefighting (ARFF) is a specialized field involving firefighters who respond to emergencies involving aircraft, typically at an airport. Firefighters involved in ARFF are often trained for rapid response to an aircraft emergency, as well as for evacuation of an aircraft and rescue of passengers and crew on an aircraft. Firefighters involved in ARFF are also typically trained for hazard materials handling, such as for the mitigation of fuel spills.

### SUMMARY

This disclosure provides a system and method for supporting training of airport firefighters and other personnel.

In a first embodiment, a method includes generating a graphical user interface for presentation on at least one display device. The graphical user interface includes one or more first screens that display different types of aircraft. The one or more first screens include first controls that allow a user to navigate around both an exterior of each aircraft and an interior of each aircraft within the one or more first screens. The graphical user interface also includes one or more second screens that display at least one airport. The one or more second screens include second controls that allow the user to navigate around each airport within the one or more second screens.

In a second embodiment, an apparatus includes at least one processing device configured to generate a graphical user interface for presentation on at least one display device. The graphical user interface includes one or more first screens that display different types of aircraft. The one or more first screens include first controls that allow a user to navigate around both an exterior of each aircraft and an interior of each aircraft within the one or more first screens. The graphical user interface also includes one or more second screens that display at least one airport. The one or more second screens include second controls that allow the user to navigate around each airport within the one or more second screens.

In a third embodiment, a non-transitory computer readable medium embodies a computer program. The computer program includes computer readable program code for generating a graphical user interface for presentation on at least one display device. The graphical user interface includes one or more first screens that display different types of aircraft. The one or more first screens include first controls that allow a user to navigate around both an exterior of each aircraft and an interior of each aircraft within the one or more first screens. The graphical user interface also includes one or more second screens that display at least one airport. The one or more second screens include second controls that allow the user to navigate around each airport within the one or more second screens.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting training of airport firefighters and other personnel according to this disclosure; and

FIGS. 2 through 27 illustrate an example graphical user interface supporting training of airport firefighters and other personnel according to this disclosure.

### DETAILED DESCRIPTION

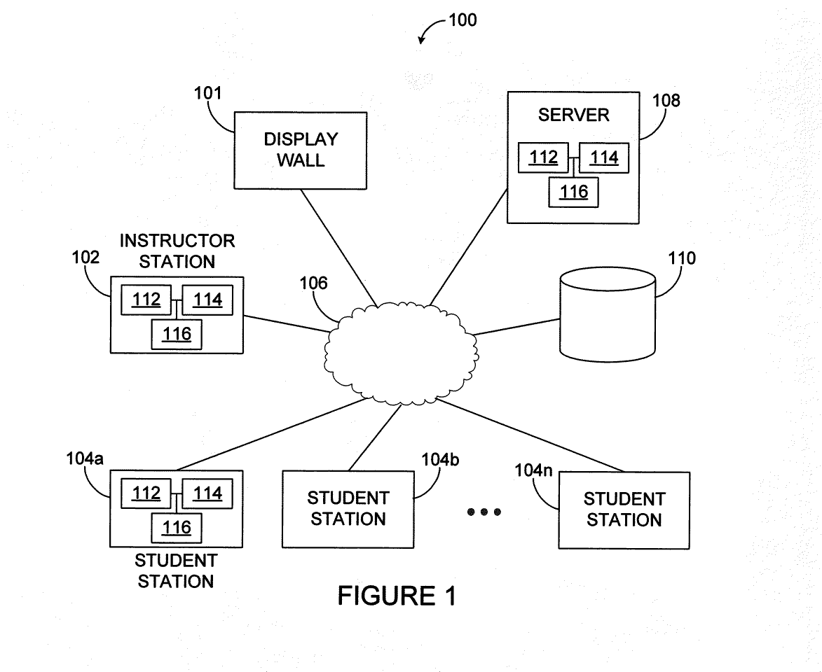

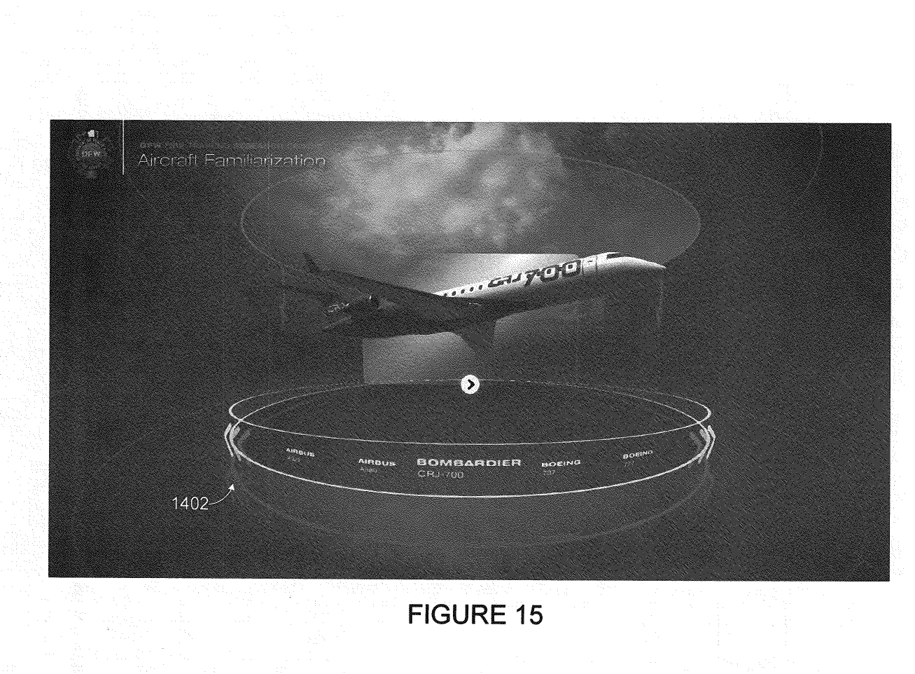

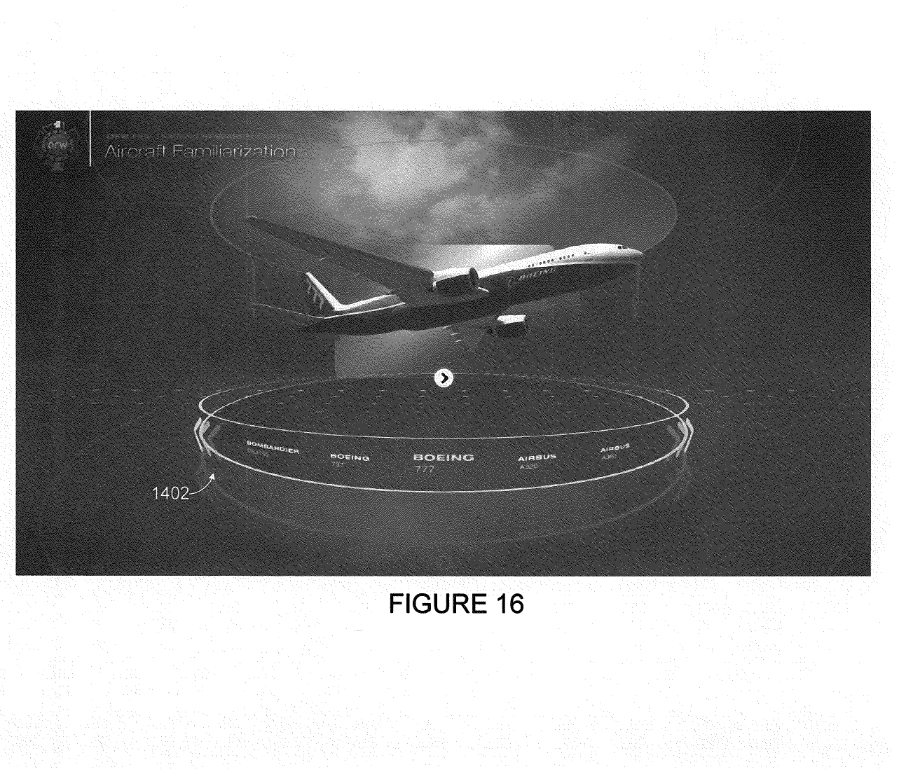

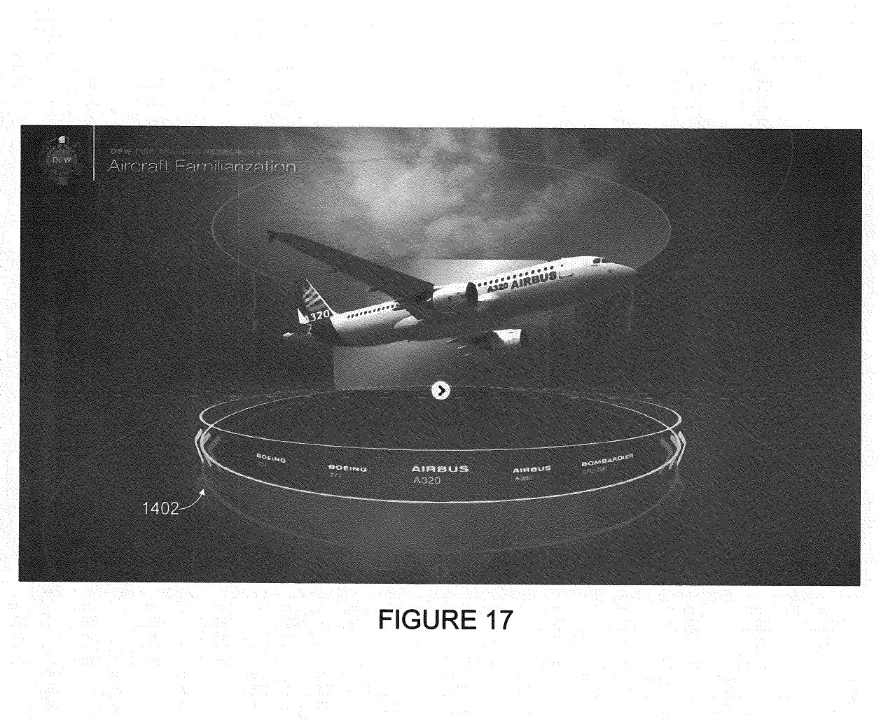

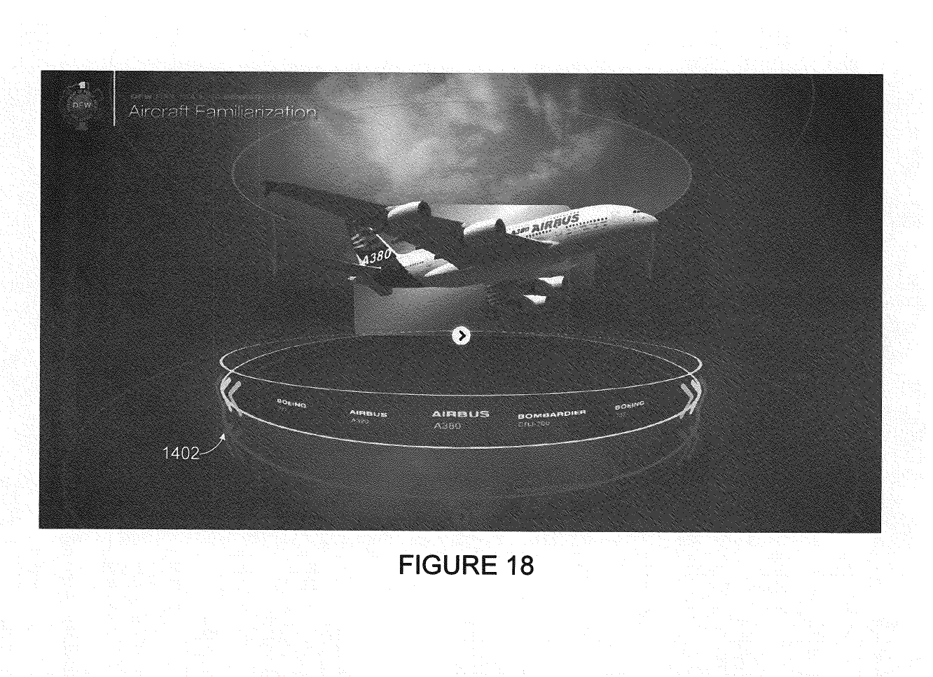

FIGS. 1 through 27, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 supporting training of airport firefighters and other personnel according to this disclosure. As shown in FIG. 1, the system 100 includes a display wall 101, an instructor station 102, and multiple student stations 104a-104n. The display wall 101 can be used to present various information during a classroom session. For example, the display wall 101 could present content related to airports or aircraft under the control of the instructor station 102. The display wall 101 could also mirror content from the instructor station 102 or from one or more student stations 104a-104n. The display wall 101 could further be touch-sensitive or include other controls allowing an instructor or student to “draw” on the display wall 101, invoke various commands, or otherwise interact with the system 100. Specific examples of display wall functions can include selecting virtual buttons, circling items, writing notations, or moving displayed objects. The display wall 101 includes any suitable display for use in a classroom setting. For instance, the display wall 101 could be formed using multiple liquid crystal display (LCD), light emitting diode (LED), or other display devices to form a 120″ or other display surface.

The instructor station 102 can be used by an instructor teaching a class. For example, the instructor station 102 could include a podium with an embedded display, a desktop or laptop computer, or a tablet computer. The instructor station 102 can also include various controls allowing interaction with an instructor. For instance, a touch-sensitive surface on the display of the instructor station 102 can allow an instructor to select virtual buttons, circle items, write notations, or perform other actions. The content and actions on the instructor station 102 can be mirrored to the display wall 101. Other control devices could include input devices such as a keyboard and mouse. The instructor station 102 includes any suitable display device and control device(s).

Each student station 104a-104n can be used by a student who is participating in a class. For example, each student station 104a-104n could include a desktop computer, laptop computer, tablet computer, or other device having an LCD, LED, or other display device for presenting class-related information to a student. Each student station 104a-104n can also include various controls allowing interaction with a student, such as a touch-sensitive surface and/or input devices such as a keyboard and mouse. The content and actions on a student station 104a-104n can be mirrored on the display wall 101 or the instruction station 102. Each student station 104a-104n includes any suitable display device and control device(s). In particular embodiments, multiple student stations could be mounted on or embedded in a table, where their associated display devices are hinged so that the display devices can be rotated up into a viewing position and lowered into a storage position.

The display wall 101, instructor station 102, and student stations 104a-104n are coupled to at least one network 106. Each network 106 facilitates communication between various components coupled to the network. For example, a network 106 may communicate Internet Protocol (IP) packets, frame relay frames, Asynchronous Transfer Mode (ATM) cells, or other suitable information between network addresses. The network(s) 106 may include one or more local area networks, metropolitan area networks, wide area networks, all or a portion of a global network, or any other communication system(s) at one or more locations.

At least one server 108 and at least one database 110 are used in the system 100 to support educational activities. For example, the database 110 can be used to store information used by an instructor and presented to students, and the server 108 can retrieve and present the information on the display wall 101, instruction station 102, and/or student stations 104a-104n. The server 108 and the database 110 could also facilitate other activities, such as presenting test questions to students and receiving and grading test answers from students. The server 108 and the database 110 could support any other or additional activities for a classroom. The server 108 includes any suitable computing device(s) supporting student training. The database 110 includes any suitable device(s) for storing and facilitating retrieval of information.

In some embodiments, the system 100 can be used to help train firefighters for aircraft rescue and firefighting (ARFF) operations. In these embodiments, the server 108 and the database 110 could be used to help teach firefighters about airport markers, configurations, and other characteristics. The server 108 and the database 110 could also be used to help teach firefighters about aircraft configurations, controls, and other characteristics. Other or additional data related to ARFF operations could also be stored and presented, such as information related to the mitigation of fuel spills. Additional details regarding the use of the system 100 for ARFF training are provided below.

In this example, each instructor station 102, student station 104a-104n, and server 108 could include at least one processing device 112, such as at least one microprocessor, microcontroller, digital signal processor, or other processing or control device(s). Each instructor station 102, student station 104a-104n, and server 108 could also include at least one memory 114 for storing and facilitating retrieval of information used, generated, or collected by the processing device(s) 112. Each instructor station 102, student station 104a-104n, and server 108 could further include at least one network interface 116 configured to support communications over at least one network, such as a wired network interface (like an Ethernet interface) or a wireless network interface (like a radio frequency transceiver).

Communications between and amongst the various components shown in FIG. 1 could occur using any suitable physical or wireless communication media. For example, each device shown in FIG. 1 could include at least one interface for communicating over physical or wireless communication links. Each device shown in FIG. 1 could include any suitable interface or combination of interfaces.

Although FIG. 1 illustrates one example of a system 100 supporting training of airport firefighters and other personnel, various changes may be made to FIG. 1. For example, the system 100 could include any number of display walls, instructor stations, student stations, networks, servers, and databases in any suitable configuration(s). Also, the functional division shown in FIG. 1 is for illustration only. Various components in FIG. 1 could be combined, further subdivided, or omitted and additional components could be added according to particular needs. For instance, the functionality of the server 108 and/or database 110 could be incorporated into the instructor station 102 and/or the student station(s) 104a-104n. As a particular example, the instructor station 102 could incorporate the functionality of the server 108 and communicate with the student stations 104a-104n via peer-to-peer (P2P) connections. In addition, the server 108 and the database 110 could support any number of classrooms, where each classroom could include at least one display wall 101, at least one instructor station 102, and at least one student station 104a-104n.

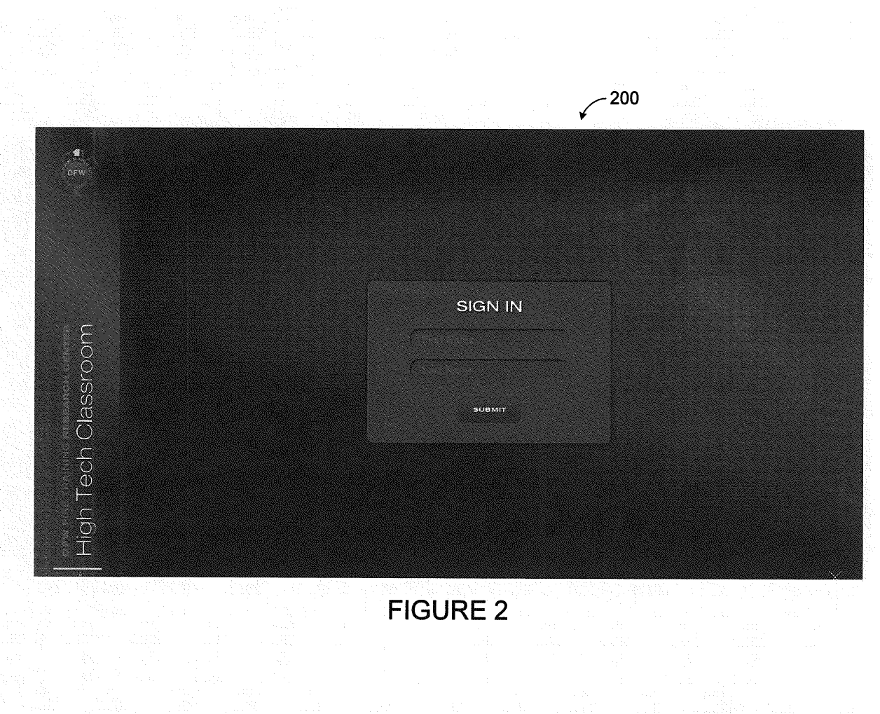

FIGS. 2 through 27 illustrate an example graphical user interface supporting training of airport firefighters and other personnel according to this disclosure. The graphical user interface could, for example, be generated by the server 108 or instructor station 102 using information in the database 110. The graphical user interface could also be presented on a display wall 101, an instructor station 102, and/or a student station 104a-104n during a classroom session.

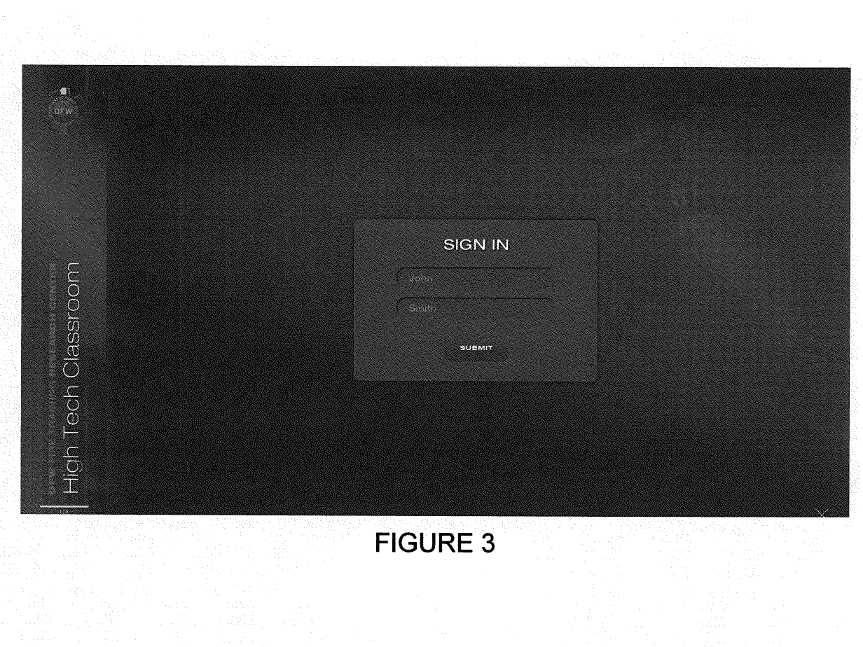

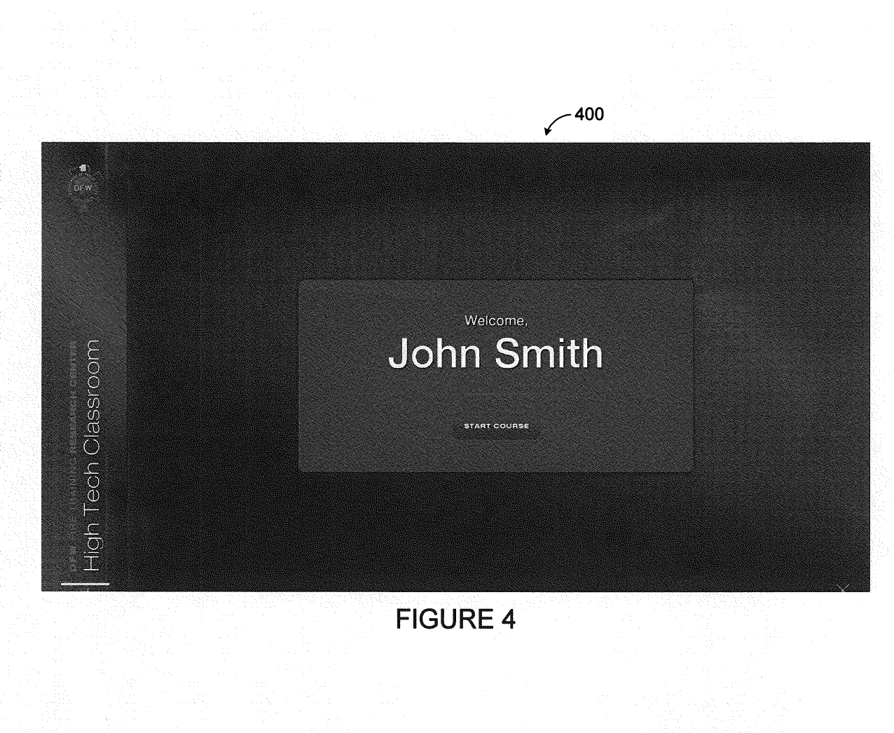

As shown in FIGS. 2 and 3, a sign-in screen 200 allows a user to enter his or her login credentials. In this example, the login credentials include the user's first name and last name, although other credentials (such as username and password) could be used. As shown in FIG. 4, once the user successfully provides his or her login credentials, a welcome screen 400 welcomes the user and gives the user an option to start an educational course. The screens shown in FIGS. 2 through 4 may be displayed only on the station 102, 104a-104n on which the user is logging in, although it could be mirrored to other devices (such as the display wall 101).

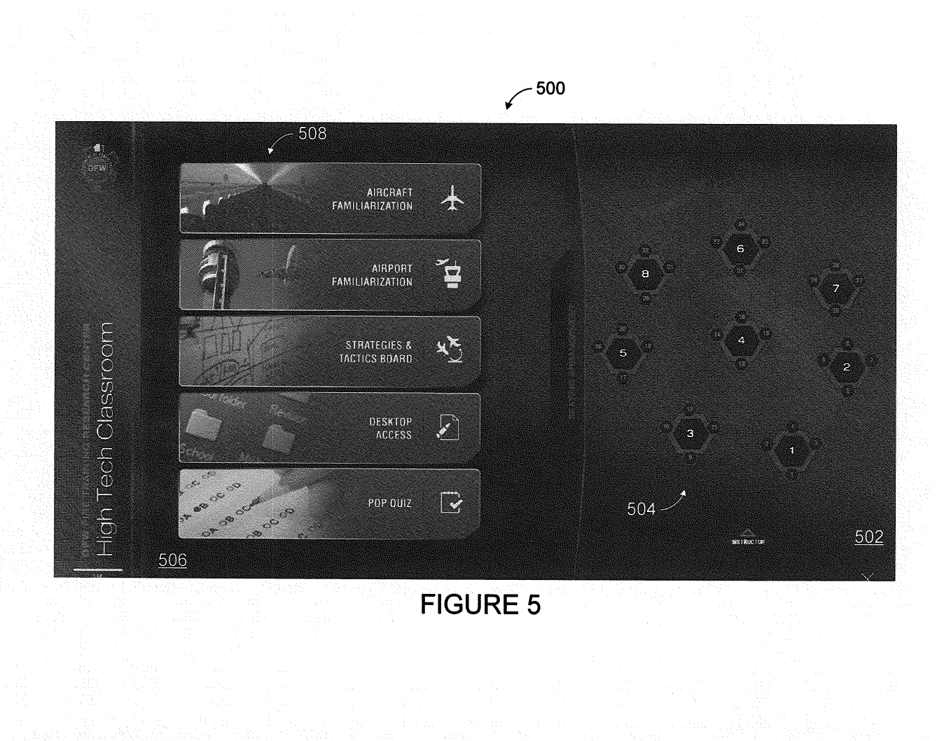

As shown in FIG. 5, once the user elects to start a course, an overview screen 500 is presented to the user. The right side 502 of the overview screen 500 shows the current seating arrangement 504 of student stations 104a-104n in the classroom, as well as the location of the instructor station 102. Different indicators could be used to indicate whether a particular student station 104a-104n is occupied, such as whether a student has logged into the system on a student station.

The left side 506 of the overview screen 500 in FIG. 5 allows the user to invoke various functions 508. In this example, the user could select an “aircraft familiarization” function, which can be used to present information to students related to one or more aircraft. The user could also select an “airport familiarization” function, which can be used to present information to students related to one or more airports. The user could further select a “strategies and tactics board” function, which allows students and instructors to develop hypothetical accident scenes and plan responses. The user could also select a “desktop access” function that allows an instructor to view the content on a selected student station 104a-104n or to mirror that content onto the display wall 101. In addition, the user could select a “pop quiz” function that allows an instructor to invoke a test of the students.

The screen 500 shown in FIG. 5 may be displayed only on the instructor station 102, although it could be mirrored to other devices (such as the display wall 101). A subset of the information shown in FIG. 5 could be presented on a student station 104a-104n or display wall 101, such as by omitting the current seating arrangement 504 from the student station's display or from the display wall 101.

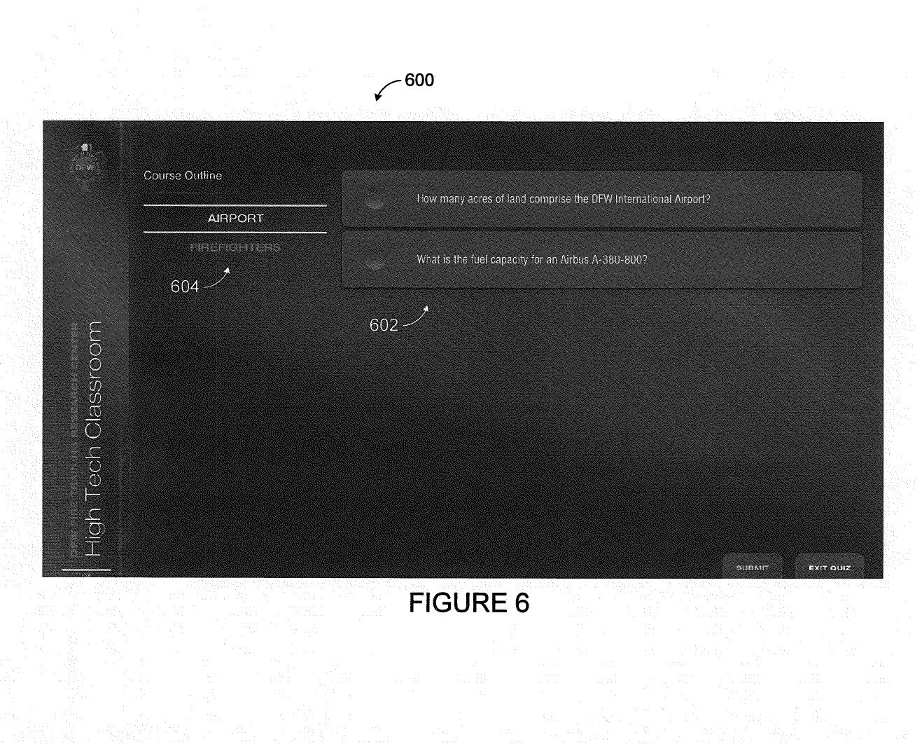

If the user selects the “pop quiz” function in FIG. 5, a test screen 600 as shown in FIG. 6 could be presented. The test screen 600 could be presented to the class on the display wall 101 and on each individual student station 104a-104n (as well as on the instruction station 102). In this example, the pop quiz includes two questions 602, although the quiz could include any number of test questions on any suitable topic(s) identified on the left by a course outline 604.

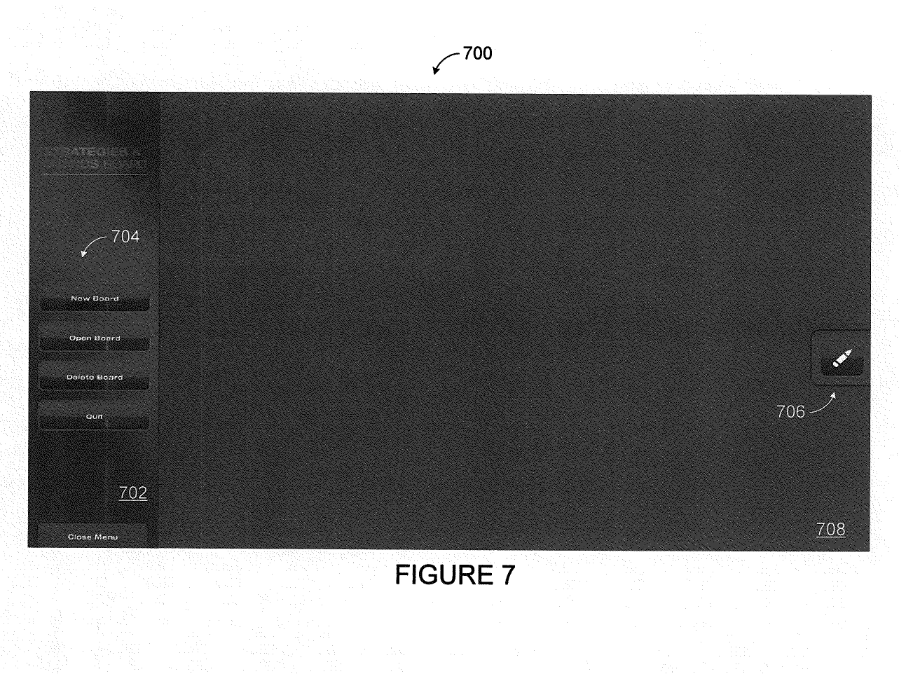

If the user selects the “strategies and tactics board” function in FIG. 5, a drawing screen 700 as shown in FIG. 7 could be displayed. The drawing screen 700 could be presented on the display wall 101 or the instructor station 102 and mirrored to the student stations 104a-104n. The left side 702 of the drawing screen 700 can selectively include a menu 704 that allows the user to create a new board, open an existing board, delete an existing board, or exit from the current screen. The user can also select an option to hide the menu 704. A control 706 on the right side 708 of the drawing screen 700 allows the user to choose to begin drawing on the screen 700.

If the user chooses to begin drawing on the screen 700, the user can then create content on the screen 700, such as by placing crashed planes, environmental barriers, and vehicles on a two-dimensional or three-dimensional airfield. The instructor and students could use this information to plan an emergency response. Sharing tools allow a scenario, developed on a student station 104a-104n, to be transmitted to the instructor station 102 and presented on the display wall 101. Annotation tools can allow for digital mark-up of scenarios. Note, however, that any other suitable content and actions could be placed and represented on the drawing screen 700.

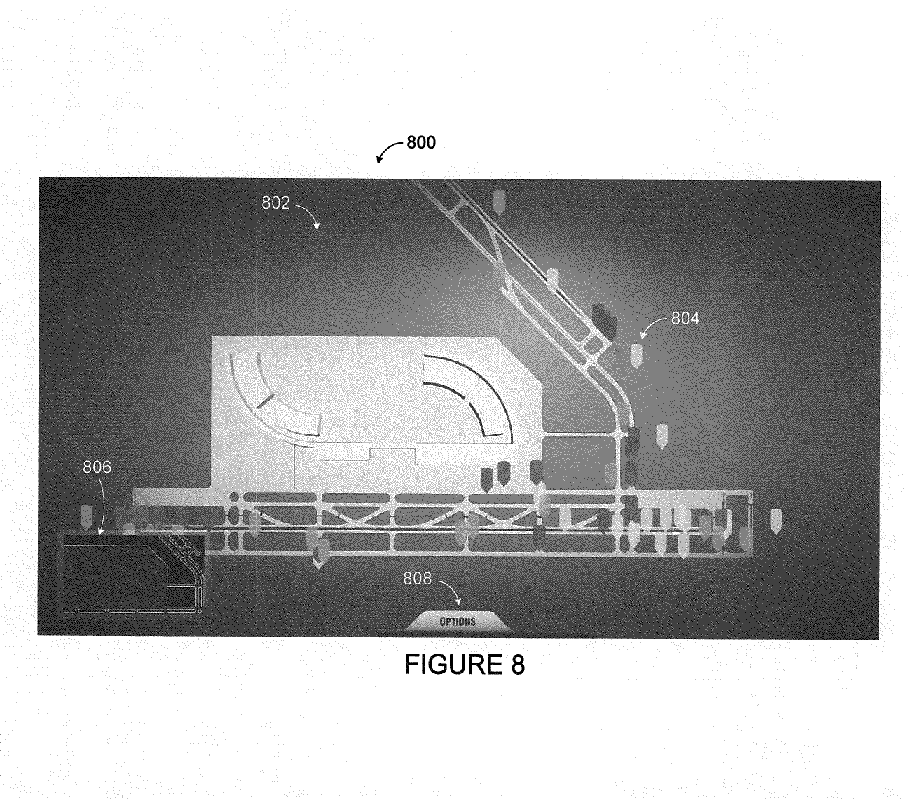

If the user selects the “airport familiarization” function in FIG. 5, an airport overview screen 800 as shown in FIG. 8 could be displayed. The overview screen 800 shows a diagram 802 illustrating at least a portion of an airport. The diagram 802 can show terminals, runways, or any other or additional features of an airport. Various indicators 804 are included in the diagram 802 to identify various markings, lights, and signage present at the airport. Each of these indicators 804 could be selected by a user to view additional information about the associated marking, light, or sign. Depending on the level of zoom, the airport diagram 802 could also be scrolled in one or more directions to view different areas of the airport. A thumbnail 806 in the bottom left corner of the screen 800 identifies the portion of the airport currently shown in the screen 800.

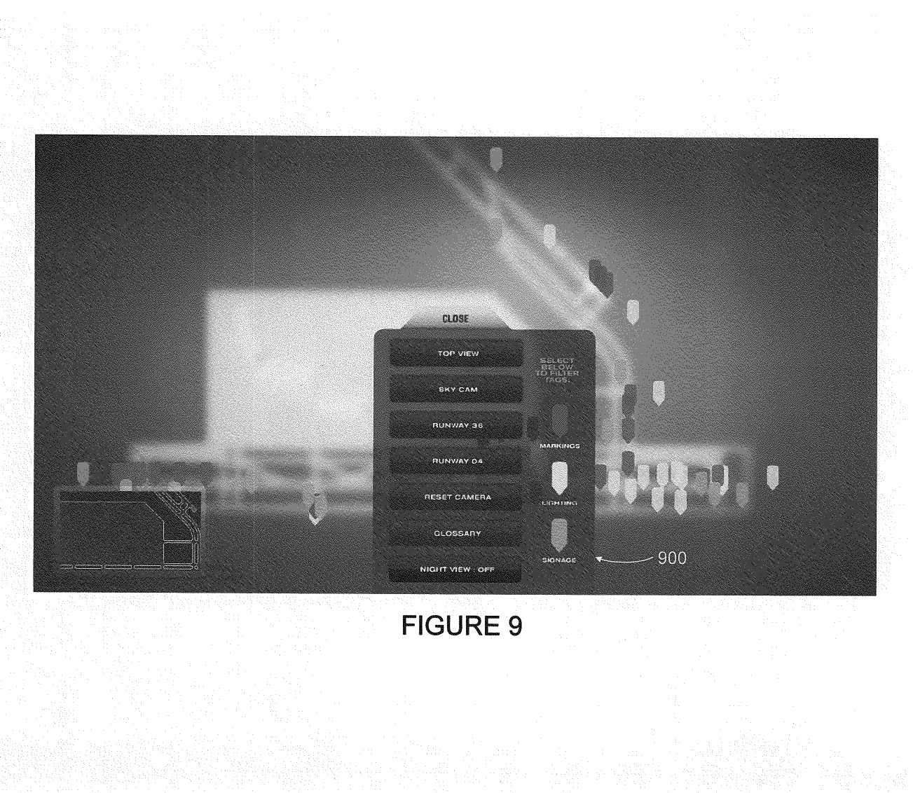

If the user selects an “Options” button 808 shown at the bottom of FIG. 8, a menu 900 as shown in FIG. 9 could be presented to the user. The menu 900 includes options for viewing the airport in different ways (such as a top view and a sky cam view) and for viewing specific runways of the airport. The user can also choose to reset the camera view to a default view or to view a glossary of terms and indicators associated with the airport. The user can further choose to filter the type(s) of indicator(s) present in the overview screen 800. Finally, the user can turn a “night view” on and off, where the night view illustrates how the airport may look at night in the dark.

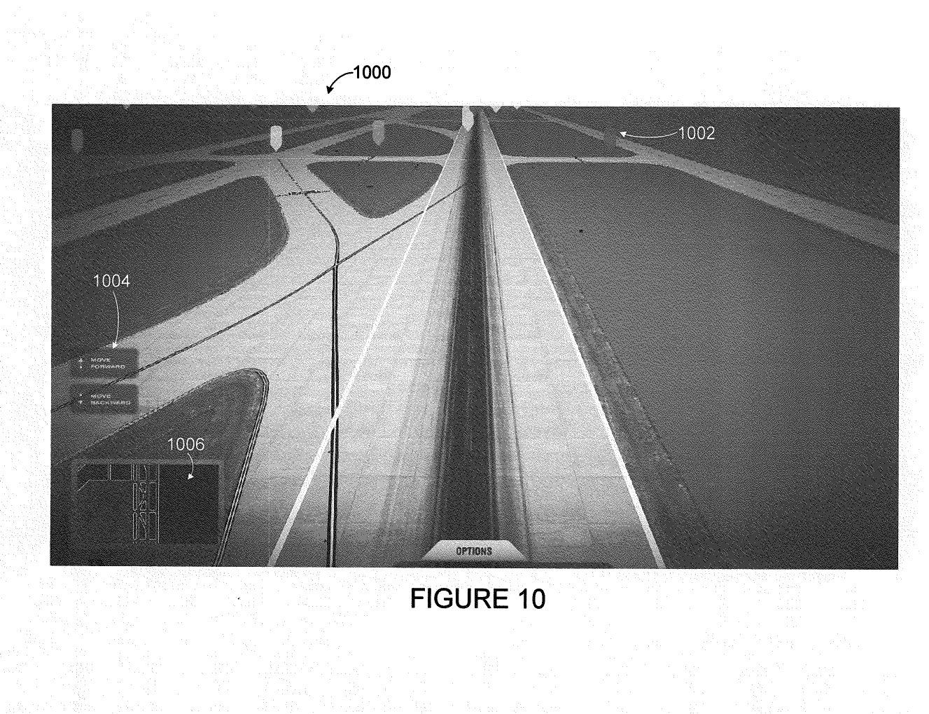

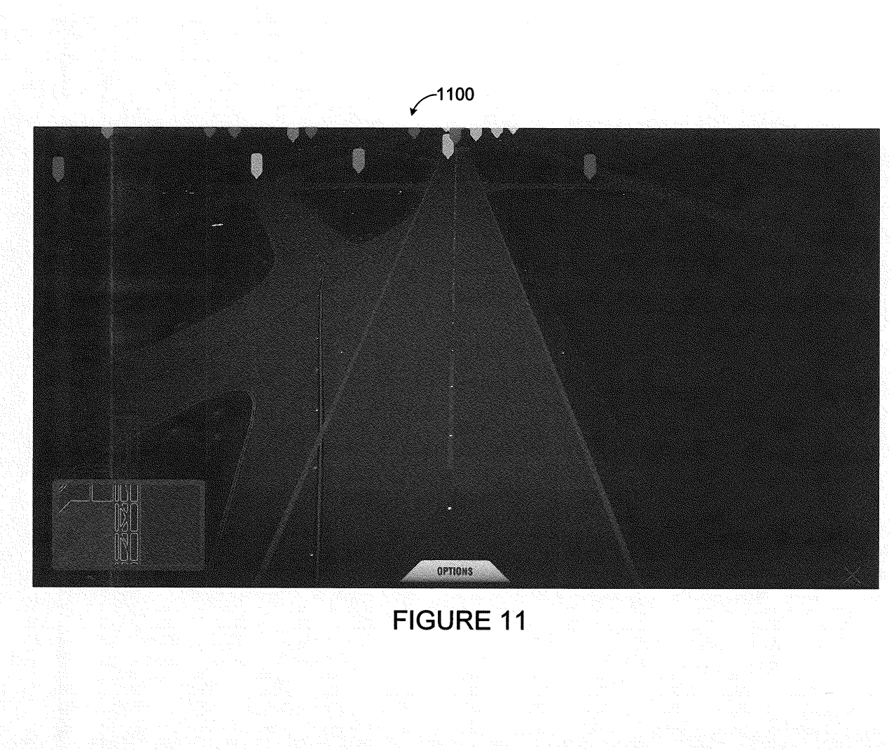

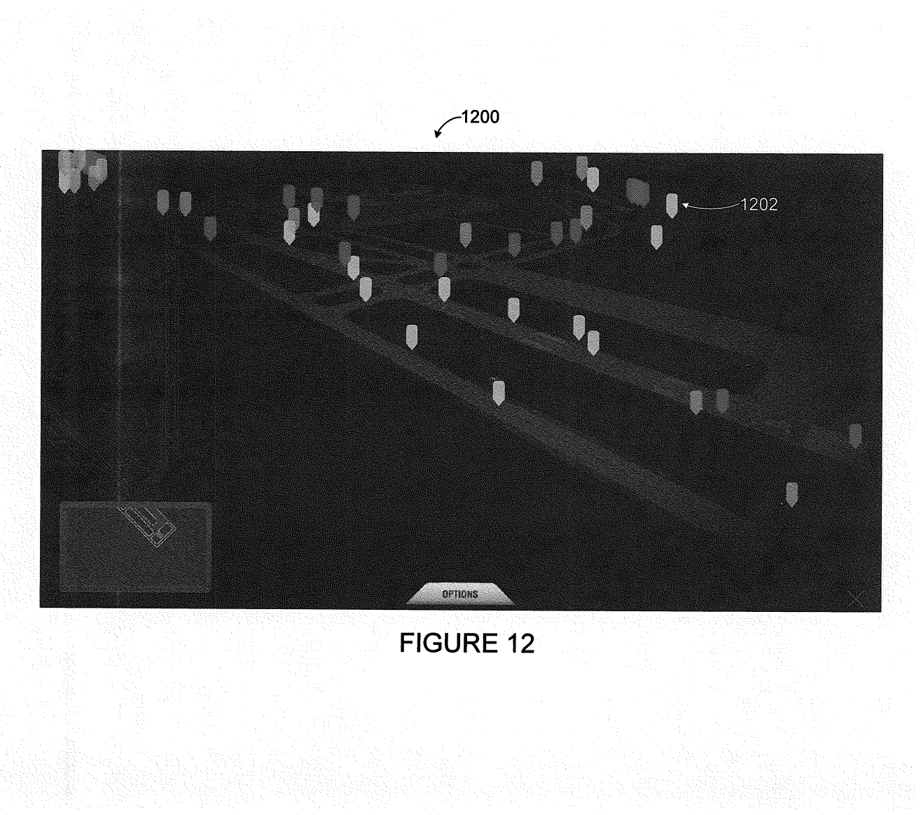

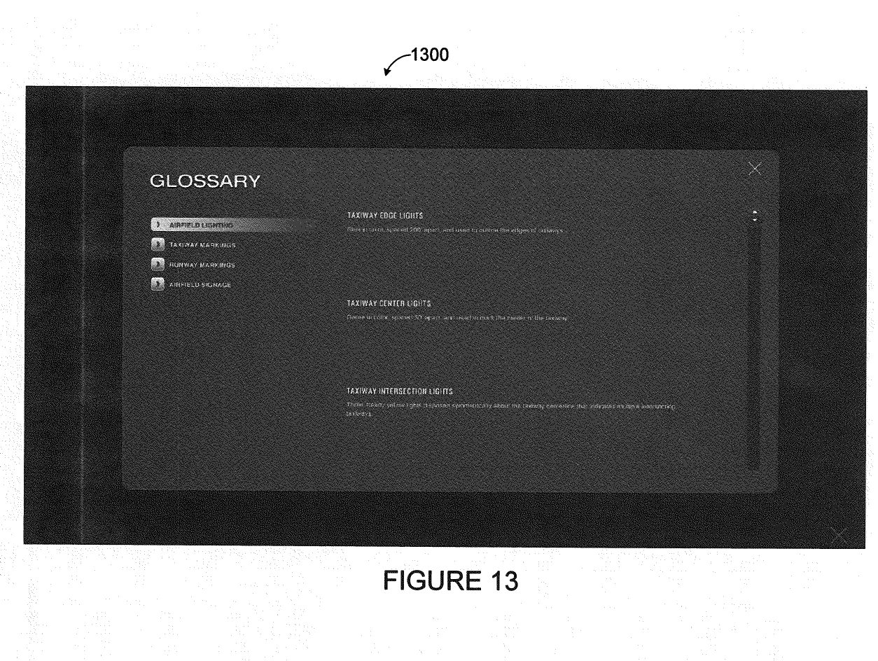

If the user selects a specific runway from the menu 900 shown in FIG. 9, a runway view 1000 as shown in FIG. 10 could be presented to the user. The runway view 1000 shows a closer view of the selected runway, along with any associated indicators 1002. Controls 1004 can be used to move along the runway in one or more directions. A thumbnail 1006 in the bottom left corner of the screen 1000 identifies the portion of the runway currently shown in the screen 1000. FIG. 11 shows a runway view 1100 of the same runway, but the runway view 1100 shows a night view of the runway. FIG. 12 shows a sky view 1200 of a portion of the airport, along with the associated indicators 1202. FIG. 13 shows a glossary screen 1300, which can be used to display information about airfield lighting, taxiway markings, runway markings, and airfield signage.

Note that in the images shown in FIGS. 8 through 12, an instructor or student could use various controls (such as the controls 1004) to virtually “move” around an airport. For example, a user could use various controls displayed on the screen to move around the airport. The user could also use conventional touch-based actions, such as touch-and-drag to move around or change orientation and pinch-in/pinch-out to zoom in and zoom out. This can allow a user to view three-dimensional or other images of an airport, view the airport from different angles, and zoom closer to and farther from the airport. This could also allow the user to virtually “drive” around the airport without actually needing to be physically at the airport.

Also note that while not shown, the “pencil” icon (control 706) shown on the right side 708 of FIG. 7 could be present overlaying the images in FIGS. 8 through 12. This can allow a user to draw notations or other content over the airport images shown on the screen.

Further note that the airport images shown in FIGS. 8 through 12 could represent a generic airport setting or be modeled after a specific airport. For example, the airport images shown in FIGS. 8 through 12 could be modeled on the specific airport for which firefighters or other personnel are being trained. Also, the system 100 could support the use of airport images associated with multiple airports. This could allow, for instance, the same system 100 to be used to train personnel for multiple airport settings. As a particular example, this could allow the server 108 and the database 110 to be remote from multiple classrooms at different airports or in different cities and to serve appropriate content to each classroom.

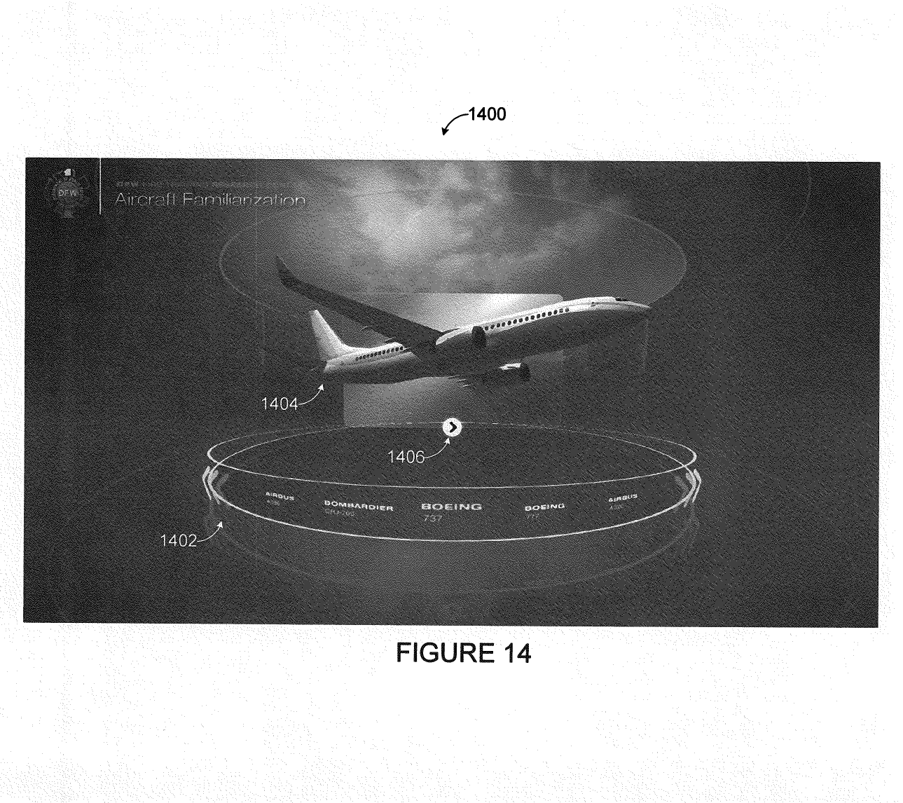

If the user selects the “aircraft familiarization” function in FIG. 5, an aircraft overview screen 1400 as shown in FIG. 14 could be presented to the user. The overview screen 1400 includes a carousel menu 1402 that identifies different aircraft that can be selected by the user. An image 1404 of the aircraft selected in the carousel menu 1402 can be shown, and a control 1406 can be used to initiate review of the selected aircraft. FIGS. 14 through 18 illustrate examples of different aircraft that could be identified in the carousel menu 1402.

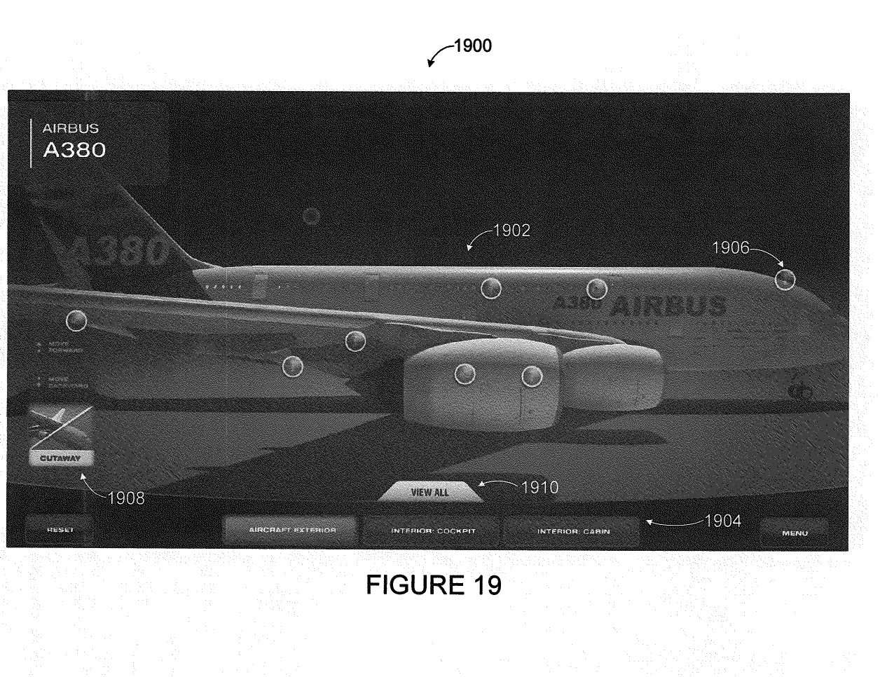

When one of the aircraft in the carousel menu is selected, an aircraft view 1900 as shown in FIG. 19 could be presented to the user. The aircraft view 1900 includes an image 1902 of a specific type of aircraft. Controls 1904 along the bottom of the aircraft view 1900 can be used to view the selected aircraft's exterior, interior cockpit, or interior cabin. In FIG. 19, the selected aircraft's exterior is being viewed. Circled features 1906 of the aircraft image identify different features of the aircraft's exterior that can be selected by the user for closer inspection. For example, selecting a circled feature 1906 could zoom in onto that particular portion of the aircraft, and animated operation of that particular feature can be shown. Controls 1908 on the left in FIG. 19 can be used to move closer to or farther from the aircraft or to select a cut-away view of the aircraft, which could allow a user to obtain a “see through” view of the aircraft with its outer skin or surface pulled back.

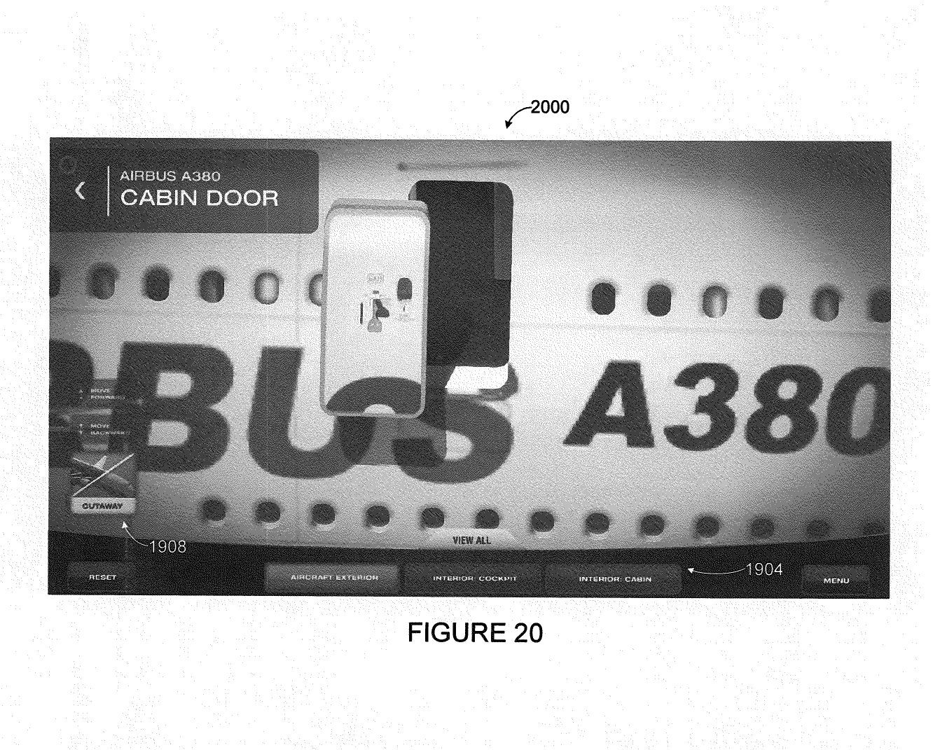

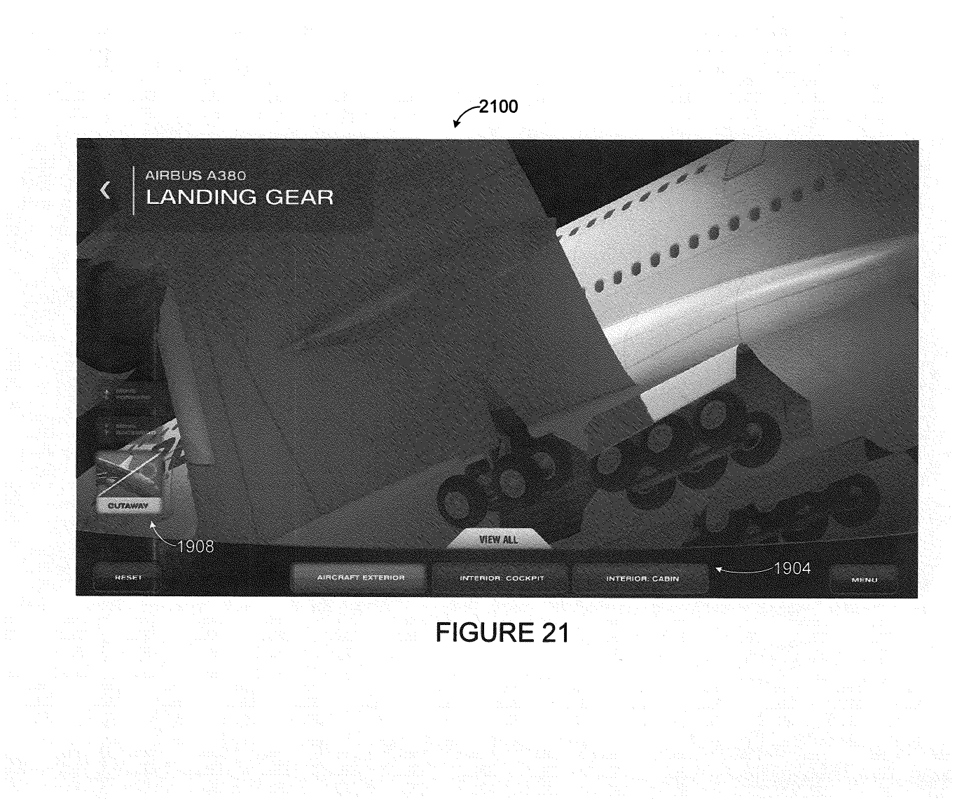

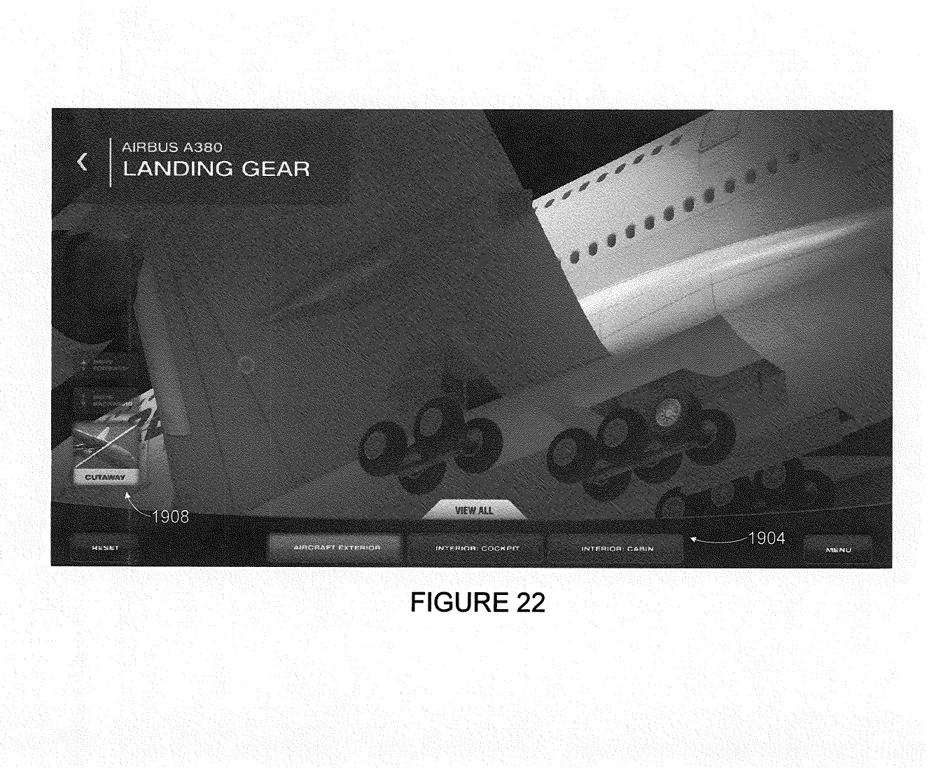

FIG. 20 illustrates a feature view 2000 of the selected aircraft. The feature view 2000 can be presented when the user selects one of the circled features 1906 in FIG. 19. In this example, the selected feature is the cabin door of the selected aircraft. After zooming in on the cabin door, animated operation of the cabin door can be shown. The same controls 1904, 1908 from FIG. 19 are present in FIG. 20. FIGS. 21 and 22 represent another feature view 2100 of the aircraft's landing gear, where operation of the landing gear can be animated.

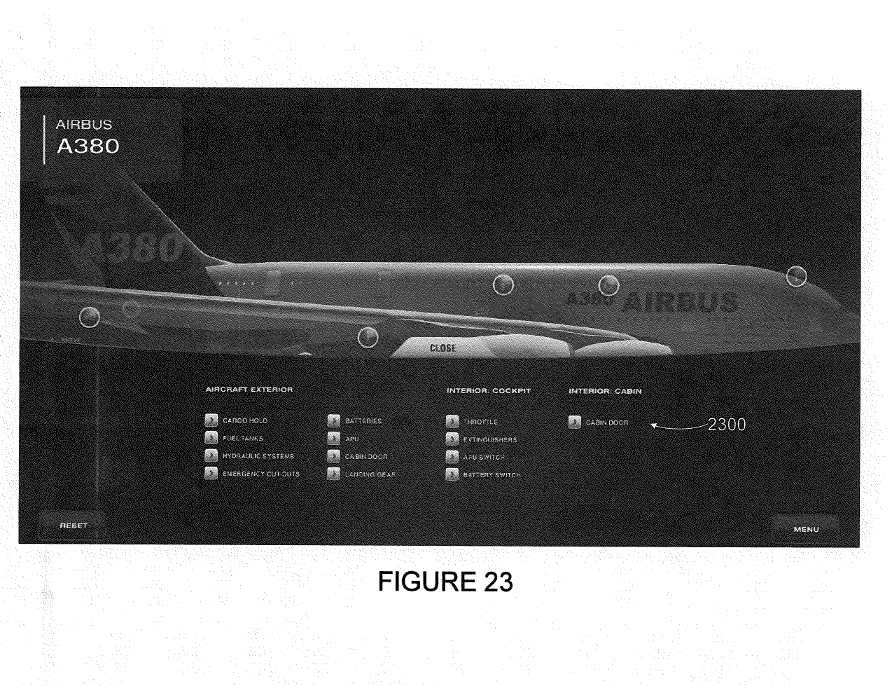

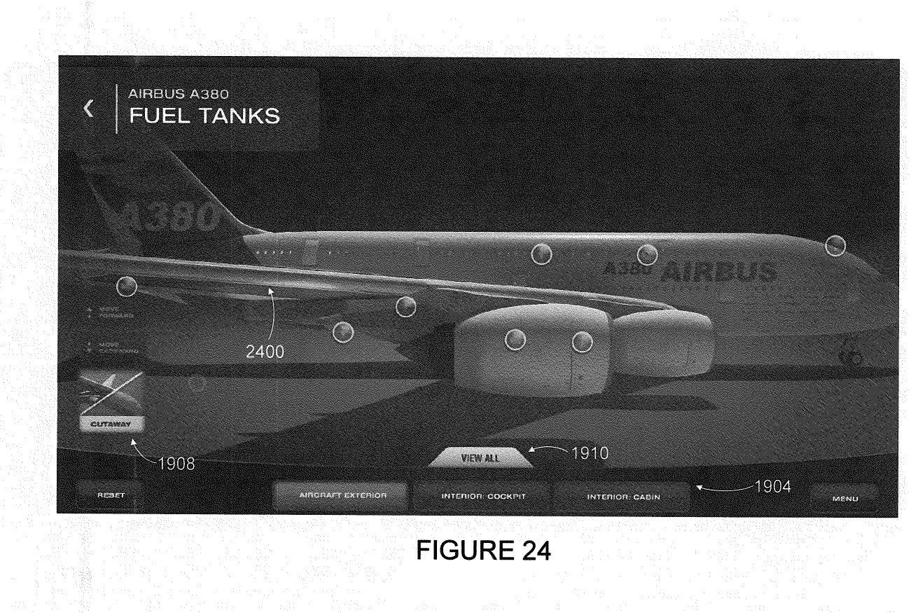

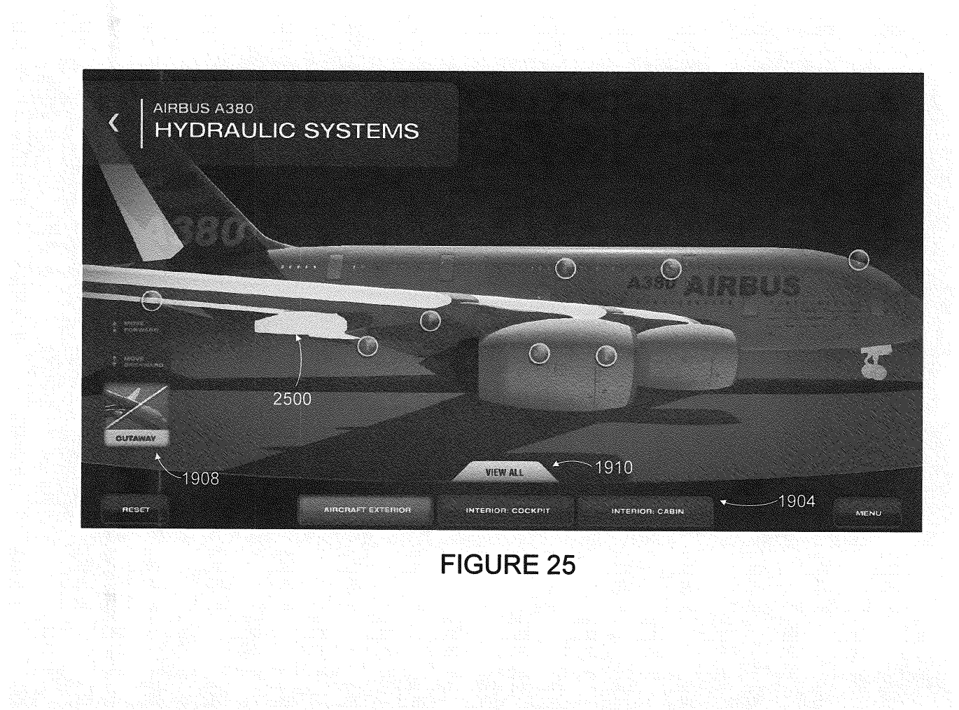

FIG. 23 illustrates an example menu 2300 of different parts of the aircraft that can be presented to the user. The menu 2300 in FIG. 23 can be presented if the user selects the “View All” option 1910 in FIG. 19. The menu 2300 in FIG. 23 can be used to highlight a specific part of the selected aircraft in the aircraft view 1900. For example, in FIG. 24, the user has selected to view the aircraft's fuel tanks, and the fuel tanks are identified in the aircraft view using highlighting 2400. In FIG. 25, the user has selected to view the aircraft's hydraulic systems, and the hydraulic systems are identified in the aircraft view using highlighting 2500.

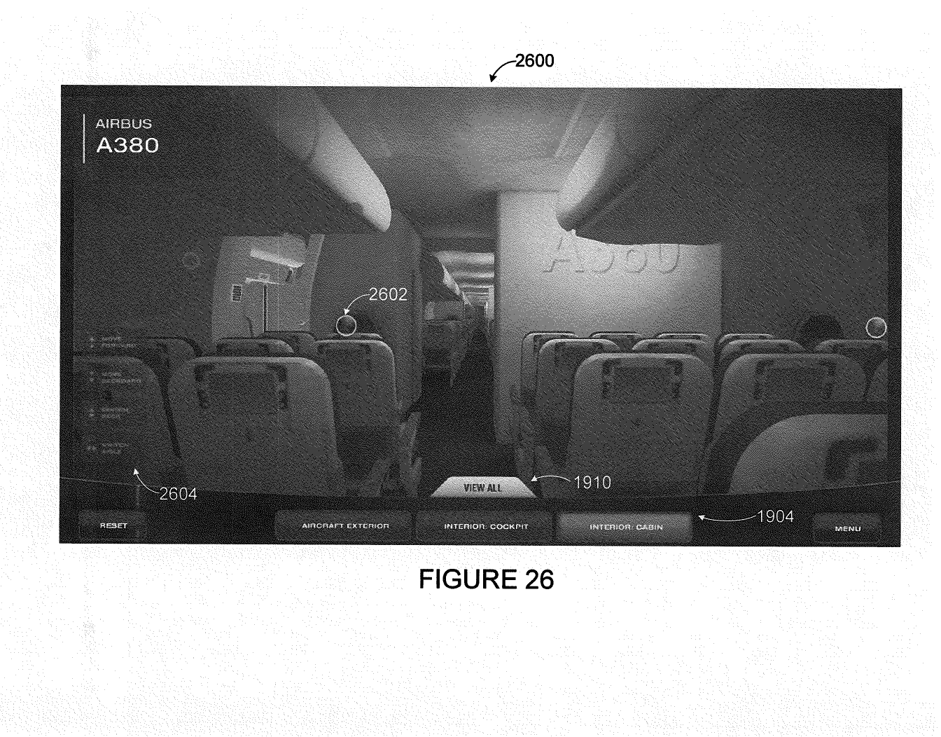

FIG. 26 illustrates a cabin view 2600 of the selected aircraft. The cabin view 2600 can again include one or more circled features 2602 that can be selected by a user to view additional details of that feature 2602. Controls 2604 on the left can be used to move forward and backward in the cabin, as well as to switch decks or aisles of the aircraft (if applicable in the selected aircraft).

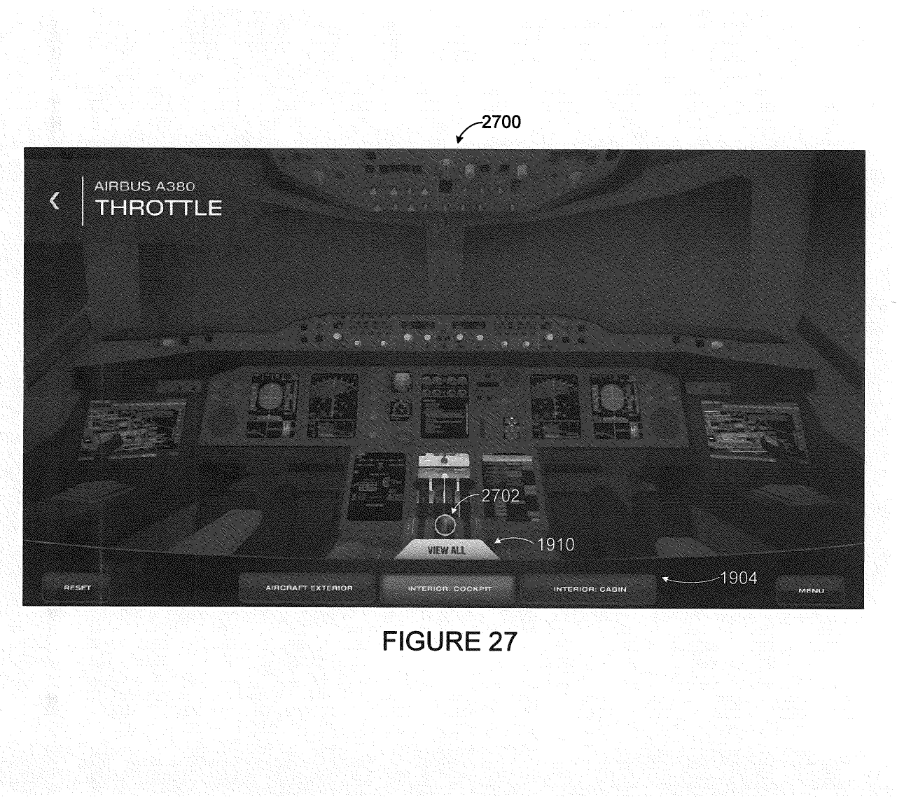

FIG. 27 illustrates a cockpit view 2700 of the selected aircraft. The cockpit view 2700 can again include one or more circled features 2702 that can be selected by a user to view additional details of that feature 2702. Moreover, the cockpit view can identify various toggle switches and other controls that can selected by the user. This can help to familiarize the user with the locations of various controls that might be needed during an actual emergency, such as a switch for controlling operation of a battery or a switch for discharging fire extinguishers on the aircraft.

Note that in the images shown in FIGS. 19 through 27, an instructor or student could use various controls 1908, 2604 to virtually “move” around an aircraft. For example, a user could use various controls displayed on the screen to move around the outside or the inside of an aircraft. The user could also use conventional touch-based actions, such as touch-and-drag to move around or change orientation and pinch-in/pinch-out to zoom in and zoom out. This can allow a user to view three-dimensional or other images of an aircraft, view the aircraft from different angles, and zoom closer to and farther from the aircraft. This could also allow the user to virtually move within the aircraft, toggle settings of various controls, and otherwise familiarize themselves with the aircraft without actually needing to physically board an aircraft.

Also note that while not shown, the “pencil” icon (control 706) shown on the right side 708 of FIG. 7 could be present overlaying the images shown in FIGS. 19 through 27. This can allow a user to draw notations or other content over the aircraft images shown on the screen.

In addition, note that the images shown in FIGS. 2 through 27 could be used in any suitable manner. For example, various images shown here could be presented on the display wall 101 and the instructor station 102 and mirrored to the student stations 104a-104n. Any content drawn on a particular screen (such as on the display wall 101 or instructor station 102) could be mirrored to the student stations 104a-104n. If enabled, content on a student station 104a-104n could also be mirrored to the display wall 101 or the instructor station 102. Depending on the mode of operation, controls within a displayed image could be enabled on some devices (like the display wall 101 or instructor station 102) and disabled on other devices (like on the student stations 104a-104n). Similarly, all or portions of some screens on some devices may not be mirrored to or presented on the screens of other devices, such as when instructor-only content is limited to display on the instructor station 102.

Finally, note that other content could be presented in one or more views displayed in a classroom. For example, many different types of vehicles are typically present in an airport environment. One or more screens can be used to display different types of vehicles that may be present during an emergency situation.

In general, using the approach described above, an instructor can use the system 100 to teach students about what a specific airport (or portions thereof) look like. Among other things, this can help to educate the students regarding how to safely navigate through the airport and how to reach certain areas of the airport, such as during an emergency situation. The instructor can also use the system 100 to teach students about what specific aircraft (or portions thereof) look like. Among other things, this can help to educate the students regarding how to safely board an aircraft, evacuate passengers and crew of the aircraft, and operate certain controls of the aircraft. In addition, the instructor can use the system 100 to simulate emergencies by placing crashed planes, environmental barriers, vehicles, and other objects onto airfields. The instructor and the students could then discuss the emergencies and discuss strategies and tactics for responding to the emergencies.

Although FIGS. 2 through 27 illustrate one example of a graphical user interface supporting training of airport firefighters and other personnel, various changes may be made to FIGS. 2 through 27. For example, the graphical user interface could include information in any other suitable format. Also, any other or additional controls could be used in the graphical user interface.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising the step of:
generating a graphical user interface for presentation on at least one display device, wherein the graphical user interface includes:
one or more first screens that display different types of aircraft, the one or more first screens including first controls that allow a user to navigate around both an exterior of each aircraft and an interior of each aircraft within the one or more first screens; and
one or more second screens that display at least one airport, the one or more second screens including second controls that allow the user to navigate around each airport within the one or more second screens.

2. The method of claim 1, wherein:
for each type of aircraft, the one or more first screens display an image of an exterior of the aircraft and multiple features of the aircraft; and
upon a selection of one of the features, the one or more first screens display an animated operation of the selected feature.

3. The method of claim 1, wherein:
for each type of aircraft, the one or more first screens display an image of an exterior of the aircraft and a list of different parts of the aircraft; and
upon a selection of one of the parts, the one or more first screens highlight the selection part of the aircraft.

4. The method of claim 1, wherein:
for each type of aircraft, the one or more first screens display an image of an interior cabin of the aircraft and multiple features of the aircraft; and
upon a selection of one of the features, the one or more first screens display additional information associated with the selected feature.

5. The method of claim 1, wherein:
for each type of aircraft, the one or more first screens display an image of a cockpit of the aircraft and multiple features of the aircraft; and
upon a selection of one of the features, the one or more first screens display additional information associated with the selected feature.

6. The method of claim 1, wherein:
for each airport, the one or more second screens display an image of the airport including one or more runways and multiple indicators located at the airport; and
the indicators represent markings, lighting, and signage at the airport.

7. The method of claim 1, wherein the second controls allow the user to view the at least one airport at different angles and under different lighting conditions.

8. The method of claim 1, wherein the graphical user interface further includes:
one or more third screens on which an emergency situation is simulated using at least one crashed aircraft, at least one environmental barrier, and at least one vehicle on an image of an airfield.

9. The method of claim 8, wherein:
the first, second, and third screens are presented on a display wall;
a first user device is configured to be used by an instructor and to provide information defining the emergency situation; and
second user devices are configured to be used by students and to support collaboration amongst the instructor and the students during the simulation of the emergency situation.

10. The method of claim 1, wherein the first controls allow the user to select:
an exterior view of each type of aircraft; and
a see-through view of each type of aircraft with an exterior surface of each type of aircraft removed.

11. An apparatus comprising:
at least one processing device configured to generate a graphical user interface for presentation on at least one display device, wherein the graphical user interface includes:
one or more first screens that display different types of aircraft, the one or more first screens including first controls that allow a user to navigate around both an exterior of each aircraft and an interior of each aircraft within the one or more first screens; and
one or more second screens that display at least one airport, the one or more second screens including second controls that allow the user to navigate around each airport within the one or more second screens.

12. The apparatus of claim 11, wherein the at least one processing device is configured to generate the graphical user interface such that:
for each type of aircraft, the one or more first screens display an image of an exterior of the aircraft and multiple features of the aircraft; and
upon a selection of one of the features, the one or more first screens display an animated operation of the selected feature.

13. The apparatus of claim 11, wherein the at least one processing device is configured to generate the graphical user interface such that:
for each type of aircraft, the one or more first screens display an image of an exterior of the aircraft and a list of different parts of the aircraft; and
upon a selection of one of the parts, the one or more first screens highlight the selection part of the aircraft.

14. The apparatus of claim 11, wherein the at least one processing device is configured to generate the graphical user interface such that:
for each type of aircraft, the one or more first screens display an image of an interior cabin of the aircraft and multiple features of the aircraft; and
upon a selection of one of the features, the one or more first screens display additional information associated with the selected feature.

15. The apparatus of claim 11, wherein the at least one processing device is configured to generate the graphical user interface such that:
for each type of aircraft, the one or more first screens display an image of a cockpit of the aircraft and multiple features of the aircraft; and
upon a selection of one of the features, the one or more first screens display additional information associated with the selected feature.

16. The apparatus of claim 11, wherein the at least one processing device is configured to generate the graphical user interface such that:
for each airport, the one or more second screens display an image of the airport including one or more runways and multiple indicators located at the airport; and
the indicators represent markings, lighting, and signage at the airport.

17. The apparatus of claim 11, wherein the graphical user interface further includes:
one or more third screens on which an emergency situation is simulated using at least one crashed aircraft, at least one environmental barrier, and at least one vehicle on an image of an airfield.

18. A non-transitory computer readable medium embodying a computer program, the computer program comprising computer readable program code for performing the step of:
generating a graphical user interface for presentation on at least one display device, wherein the graphical user interface includes:
one or more first screens that display different types of aircraft, the one or more first screens including first controls that allow a user to navigate around both an exterior of each aircraft and an interior of each aircraft within the one or more first screens; and
one or more second screens that display at least one airport, the one or more second screens including second controls that allow the user to navigate around each airport within the one or more second screens.

19. The computer readable medium of claim 18, wherein:
for each type of aircraft, the one or more first screens display an image of an exterior of the aircraft and multiple features of the aircraft; and
upon a selection of one of the features, the one or more first screens display an animated operation of the selected feature.

20. The computer readable medium of claim 18, wherein:
for each type of aircraft, the one or more first screens display an image of an exterior of the aircraft and a list of different parts of the aircraft; and
upon a selection of one of the parts, the one or more first screens highlight the selection part of the aircraft.

21. The computer readable medium of claim 18, wherein:
for each type of aircraft, the one or more first screens display an image of an interior cabin of the aircraft and multiple features of the aircraft; and
upon a selection of one of the features, the one or more first screens display additional information associated with the selected feature.

22. The computer readable medium of claim 18, wherein:
for each type of aircraft, the one or more first screens display an image of a cockpit of the aircraft and multiple features of the aircraft; and
upon a selection of one of the features, the one or more first screens display additional information associated with the selected feature.

23. The computer readable medium of claim 18, wherein:
for each airport, the one or more second screens display an image of the airport including one or more runways and multiple indicators located at the airport; and
the indicators represent markings, lighting, and signage at the airport.

24. The computer readable medium of claim 18, wherein the graphical user interface further includes:
one or more third screens on which an emergency situation is simulated using at least one crashed aircraft, at least one environmental barrier, and at least one vehicle on an image of an airfield.
